(19) United States
(12) Patent Application Publication
(10) Pub. No.: US 2005/0091140 A1
(43) Pub. Date: Apr. 28, 2005

(54) Valuation tool and method for electronic commerce including auction listings

(76) Inventors: Jeff Sloan, Birmingham, MI (US); Richard Sloan, Birmingham, MI (US); Chris Cameron, Royal Oak, MI (US)

Correspondence Address: Thomas D. Helmholdt;Young & Basile, P.C., Suite 624, 3001 West Big Beaver Road, Troy, MI, 48084, US

(21) Appl. No.: 10/693,560

(22) Filed: Oct. 24, 2003

(51) Int. Cl. G06F 17/60

(52) U.S. Cl. 705/37

(57) ABSTRACT

A valuation data analysis system includes a valuation data mining system configured to extract valuation data from at least one of a plurality of publicly listed items for sale and a non-public privately available database of previously sold items, and a valuation data processing system configured to receive the valuation data, the data processing system configured to process the valuation data to identify relationships between similar items currently listed for sale and previously sold items. The process of the valuation data analysis system can include the steps of identifying a listed item open for bidding at auction, identifying a plurality of auction listings for items similar to the item open for bidding, mining valuation data from the identified auction listings, and identifying relationships between the listed item open for bidding, closing prices for similar items, and the mined valuation data from the identified auction listings.

### FIELD OF THE INVENTION

The present invention relates generally to web-based commerce and, more particularly, to a system permitting valuation of items listed for sale based on historical and present valuations including items offered through web-based auctions.

### BACKGROUND OF THE INVENTION

On-line web-based sales sites, sometimes referred to as e-commerce sites, have increased dramatically and now provide a new and flexible market for a broad range of items. Items can be offered for sale or can be auctioned on-line in order to increase market penetration and to provide an easy convenient way for customers to obtain a variety of new, second-hand and/or refurbished items. The large number of e-commerce sites provide numerous options for listing items for sale. Currently, there is no simple consolidated manner to search and locate items for sale in order to determine price ranges, quantity available, and/or quality of the particular item being offered. This information would be useful for purchasers in general, and would be useful for buyers preparing to place a bid at an on-line auction web site.

### SUMMARY OF THE INVENTION

The present invention provides a valuation data analysis system including a valuation data mining system configured to extract valuation data from at least one of a plurality of publicly available listings of items for sale and a non-public or privately available database of previously sold items, and a valuation data processing system configured to receive the valuation data. The data processing system is configured to process the valuation data to identify relationships between similar items currently listed for sale and previously sold items. The present invention can provide a comparative display including a currently listed item for sale of interest to a potential buyer compared with respect to valuation data based at least in part on the relationships identified by the valuation data processing system. The system can be incorporated into an on-line auction web site hosting auctions of interest to a potential bidder, or can be separate from any particular auction or sale web site. In either case, the system according to the present invention can include access to data either limited to the one particular auction or sale web site, or can include data from a plurality of auction or sale web sites for comparison purposes.

A method for a valuation data analysis system according to the present invention includes the steps of identifying a set of item search parameters, identifying a plurality of listings based on the item search parameters, identifying valuation data for each of the identified plurality of listings, and displaying a comparison of listings as a function of the set of item search parameters based on at least one of the identified valuation data for the identified plurality of listings. According to the present invention, a display can be provided where comparison is related to at least one of a minimum closing price, a maximum closing price, and an average or median closing price for similar listings. The comparison display can also include a graphic bell curve of closing prices for similar listings.

A method for a valuation data analysis system according to the present invention can also include the steps of identifying a listed item open for bidding at auction, identifying the plurality of auction listings for items similar to the item open for bidding, mining valuation data from the identified auction listings, and identifying relationships between the listed item open for bidding, closing prices for similar items, and the mined valuation data from the identified auction listings. The valuation data can be displayed in at least one of text and graphic format for comparison and evaluation by a potential bidder. The valuation data can be obtained through automated mining of old and/or new auction listings. The new auction listings can help identify other items open for bidding at auction which may currently be offered at a lower price to the bidder than the item currently being viewed.

A method for a valuation data analysis system according to the present invention can also include the steps of identifying an item to be purchased, identifying a plurality of market places selling items similar to the identified item, selecting a market place based on at least one of current sales of items similar to the identified item in the market place, bidding activity related to items similar to the identified item, comparison of quality characteristics related to items similar to the identified item, and comparison of sale completion data related to purchases of items similar to the identified item, collecting data for items similar to the identified item offered in the identified market places, analyzing the data to determine supply and demand, and based on at least the determined supply and demand, determining a relative purchase price for the identified item in the market place. The collected data can be analyzed to identify if sufficient data is available for a statistically meaningful comparison with the identified item. The collected data can also be analyzed to identify related items similar to the identified one, where the related items have quality characteristics different than the quality characteristics associated with the identified item.

According to the present invention, the item market data can include identification of sellers and/or purchasers/bidders on a particular item. The present invention can permit search criteria including sellers of uncompleted sales, such as incomplete sales due to failure to meet minimum bid requirements, and/or search criteria for purchasers/bidders who have purchased articles for below market value, where such purchasers/bidders may be willing to resell the item for more than was paid for the article in order to make a profit, and/or search criteria for purchasers/bidders who paid more than market value, such as enthusiastic collectors who may interested in obtaining additional information about rare items in order to complete their collections. The seller/purchaser/bidder information can include a unique identification code or number, e-mail address, and/or user name or the like.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a simplified schematic diagram illustrating a valuation data analysis system according to the present invention for aggregating item market data related to the value of items sought by purchasers in market places and/or bidders in an on-line auction environment;

FIG. 2 illustrates a method according to the present invention for modeling item value for potential purchasers and/or bidders taking into consideration certain qualitative and quantitative variables;

FIG. 3 illustrates a method according to the present invention of selecting market data variables to model a price range taking into consideration the influence of certain qualitative aspects of the source of the price, price trends, and other forecasting tools; and

FIG. 4 illustrates a method according to the present invention to actively search or bargain hunt for certain auction items based on the current bid price compared to certain price and market data for the item.

### DESCRIPTION OF THE PREFERRED EMBODIMENT

The present invention relates generally to web-based commerce and, more particularly, to a system for creating a searchable database of historical and current prices, and other qualitative attributes about the source of the data, to determine appropriate value ranges for an item being sought by a purchaser, such as a bidder in an auction or other purchasing environment. The present invention can also provide a system to allow a purchaser/bidder to find the best bargains available in an identified market place, such as an auction environment, by comparing certain price and qualitative data with prices for items currently identified as being for sale at various sites, such as bid prices at auction sites.

For purposes of illustration, the present invention will be described with respect to particular environments and configurations by way of example and not limitation. It should be understood that the various configurations and environments can be used in different combinations than those specifically disclosed and that features of one scenario can be combined with features of another example without departing from the present invention. For purposes of the description, the present invention will be disclosed with respect to an online, e-commerce, auction value tool, while the present invention is not limited to an auction environment, since it can provide a valuation tool for any market place where pricing, quantity, quality, and other attributes are publicly available and/or privately available through an accessible database.

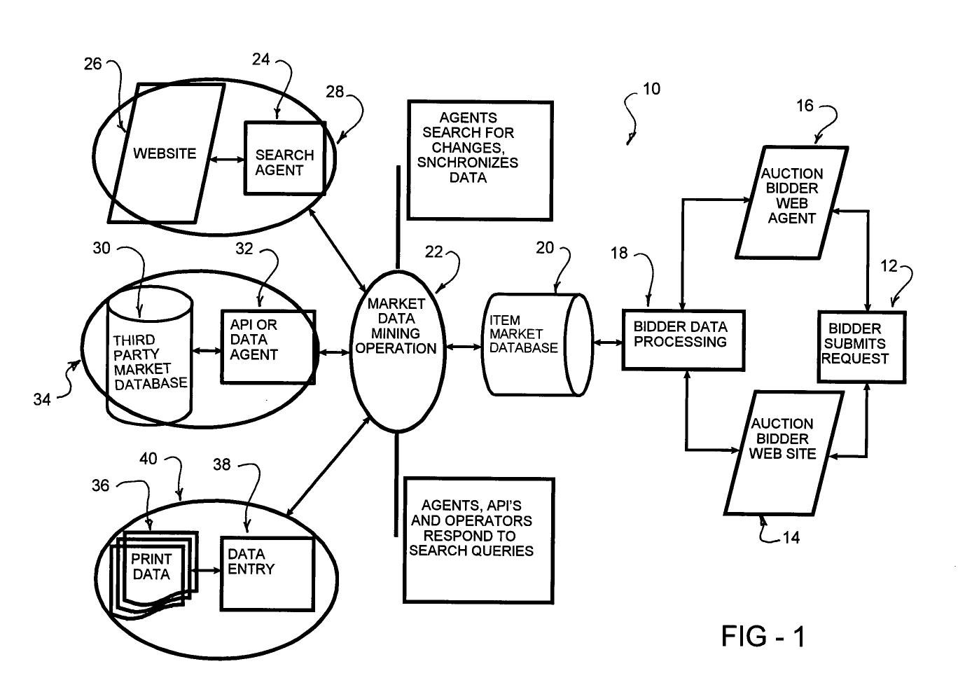

Referring now to FIG. 1, a valuation data analysis system 10 according to the present invention is schematically illustrated in FIG. 1, by way of example and not limitation, for an auction web site environment communicating with a potential purchaser or bidder through a web browser interface. A potential bidder can submit a request as illustrated in box 12 through the auction bidder web site 14 and/or auction bidder web agent 16. The submitted request is transferred from the auction bidder web site 14 and/or auction bidder web agent 16 to a bidder data processing system 18. The data processing system 18 interacts with an item market database 20 in response to the submitted request from the bidder. The item market database 20 can include current and historical valuation data. The valuation data can include quantitative values and qualitative values usable by the processing system 18 in responding to the submitted request. The current and historical valuation data can be collected from various public and/or non-public sources of information.

In general, the valuation data collection process is referred to as market data mining operation 22. By way of example and not limitation, the market data mining operation 22 can include active or passive search agents 24, sometimes referred to as spiders or crawlers, reading publicly available listings of items for sale on various web sites 26 in order to extract valuation data for inclusion in the item market database 20. The search agents 24 can search for changes to previously existing data in order to synchronize the data in the item market database for auctions that are still open to bidding, and/or can search for changes, such as auctions ending in order to synchronize the data to the final winning bid, and/or can search for new listings of items for sale to be included in the item market database 20. The search agents 24 can operate continuously and/or can operate in response to specific submitted requests as required depending on the circumstances and the operation of the data processing system 18. The search agents 24 and web sites 28 correspond to publicly available information 28 available to the item market database 20. The market data mining operation 22 can also include third party market databases 30, such as a private database, accessible through an API or data agent 32. The third party market databases 30 and data agents 32 correspond to non-public or privately available information 34 to the item market database 20 through the market data mining operation 22. The publicly available information 28 and privately available information 34 are generally available in electronic form for automatic access and incorporation into the item market database 20. Print data 36 can also be provided to the item market database 20 through data entry 38 of the valuation data to the item market database 20 through the market data mining operation 22. The print data 36 and data entry 38 corresponding to non-electronically available information 40.

If sufficient valuation data is available in the item market database 20 to immediately respond to the submitted request, the data processing system 18 manipulates the available valuation data according to a program stored in memory for delivery of valuation data to be displayed to the potential purchaser/bidder through the auction bidder web site 14 and/or auction bidder web agent 16. If sufficient information is not immediately available in the item market database 20, the potential purchaser/bidder can be informed to wait while additional information is retrieved and/or can be given the option to modify the submitted request or cancel the submitted request. If the bidder is instructed to wait for additional information to be collected, or if the bidder selects an alternative option, such as email delivery of the valuation data, the data processing system 18 instructs the item market database 20 and market data mining operation 22 to send out additional search agents 24, API, or data processing operators to find, collect, and input sufficient valuation data in order to respond to the submitted request.

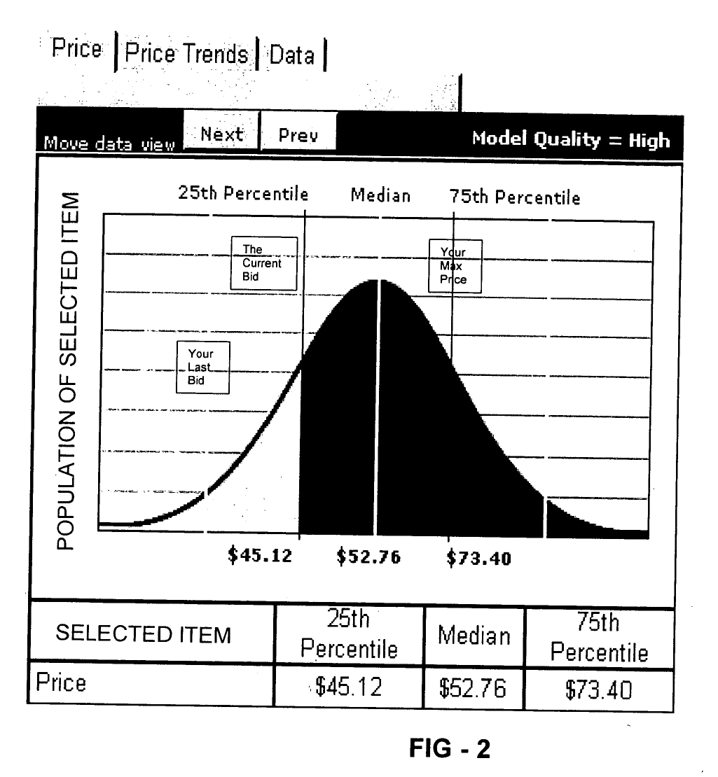

Referring now to FIG. 2, the valuation data to be displayed in response to the submitted request can be illustrated in any desired graphic and/or text form. By way of example and not limitation, the valuation data can be manipulated by the data processing system 18 in order to display a price curve expressed as a standard bell curve, price trends, and/or data variables. The displayed data can include by way of example and not limitation, such information as minimum price, maximum price, median price, last bid, current bid, maximum bid, and/or any desired percentile, such as 25^{th} percentile and/or 75^{th} percentile of the valuation data to be displayed. The displayed configuration and information is selected to provide feedback of assistance to a potential purchaser/bidder in assessing an appropriate item price or valuation range for the particular item of interest to the potential bidder/purchaser. The valuation data to be displayed can also provide an indication of the quality of the valuation data being displayed as a result of the manipulation of the valuation data by the data processing system 18 which can include qualitative, as well as quantitative values with respect to the available valuation data from the item market database 20.

The valuation data analysis system 10 can be accessed by a user through a standard commercially available web browser. The system 10 can include an icon, toolbar button, system service, or similar means to allow a user to interact with the system 10. The system 10 can include two primary functions: (1) the first function being means for measuring and suggesting an appropriate value for an item or items being sought in a market place, such as an online auction by any buyer or bidder; and (2) the second function being means for searching for items in a market place, such as auction web sites, that fall within certain value and/or price parameters supplied by any buyer or bidder.

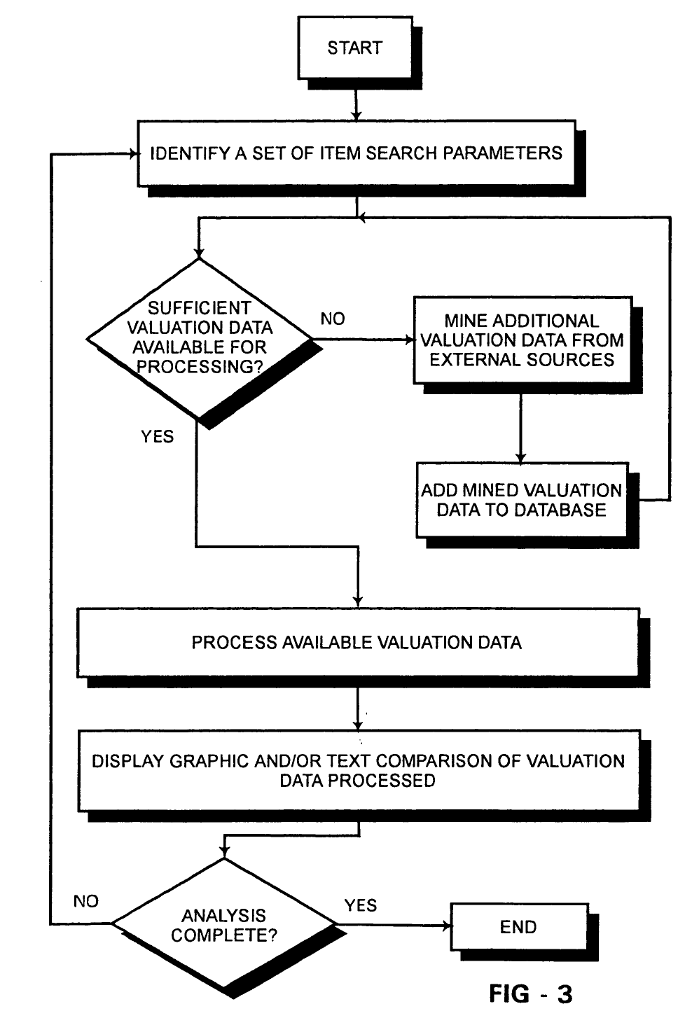

Referring now to FIG. 3, the process of measuring value for an item or items being sought by a buyer or bidder according to the present invention can include a user operating a web browser in order to obtain access to a web site, either directly associated with the valuation data analysis system, or affiliated with the valuation data analysis system through a corresponding marketplace web site and/or auction web site. By way of example and not limitation, when a user is currently on an auction web site, the user typically would like to measure the value of an item of interest currently displayed on the web browser. The user can either click on the specific item sought being displayed on the web page (assuming several items are displayed) or can enter certain required data directly to forms presented by the valuation data analysis system. If the user has a single item displayed on the web browser, then clicking on the valuation data analysis system will “scrape” certain data out of the displayed page and present it on a web page form displayed by the tool, such as a dialogue window sized page overlaid on the browser. The item dialogue window displayed to the user can contain required item information fields, either filled in automatically by pulling or “scraping” the data from the auction site, or the data can be entered directly on the form by the user. The user can edit data pulled from the auction web page to ensure accurate value measurement. In addition to information about the item, the valuation data analysis system according to the present invention will collect the starting bid, current bid, the user's last bid, and the user's maximum bid. This data can be pulled from the auction site. The user can be asked to confirm that the data in the window is accurate. Once the user has verified the data, the user can click to the next step, which is to indicate or modify the search preferences. The users of the valuation data analysis system according to the present invention can have the option to store certain preference and option data related to search queries and data presentment. Preference data can include, but not be limited to, ordering the search to place higher relevance on data found from certain web sites or other sources, or ordering the search to only seek exact matches to the item being sought in the auction. The next screen can display certain preferences for the search to be submitted, and once these preferences are accepted by the user, the system can indicate a ready to initiate search condition to the user. A confirmation window can ensure that the user has validated the data and wants to search on the parameters provided. Once initiated, the search can take certain item data points and begin searching for relevant data as follows: (1) the item market database 20 maintained by the valuation data analysis system 10 can be searched. The database can maintain an extensive “library” of reference material on certain items presented in online auctions. If the data requested by the search is found in its entirety, or in adequate volume, in the item market database 20, then the search ends and returns the results to the user. If not all or any of the data requested by the search is found in the item market database 20, then the search proceeds to alternative sources of relevant data. (2) Other relevant item market data can be found in several sources, including but not limited to: auction web sites (including the one the bidder is currently using), other web sites, other online databases. The valuation data analysis system according to the present invention can initiate a search process that can scrape certain data out of various selected web sites. This process can search for certain item data keywords and tags where available. Data can be returned to the item market database 20 and inserted into the appropriate tables thereby allowing the database to grow with each search. As time/date data is highly relevant for most searches, all records can be timed/date stamped. (3) If no data or extremely limited data has been found after all relevant source data has been searched, the user can be notified of those results and given the option to change or refine the search criteria or modify item data.

The valuation data analysis system 10 according to the present invention can actively maintain item record data by scraping and searching from relevant online data sources on predefined intervals. In some cases, the information can by synchronized in a “real-time” format by using technology capable of identifying when changes occur at a source data set and then running a routine to synchronize the changes with the item market database 20.

Once search data has been retrieved, the search data will be analyzed by the valuation data analysis system 10 using an appropriate market data analysis engine. The market data analysis engine can consider all data retrieved (i.e. the sample's population) and begin a qualitative analysis of that population. The population can include item market data, by way of example and not limitation, such as: item data; item code; item description (general); item description (detailed); item quality rating; seller data; seller code; seller description; seller qualitative points A-X (multiple data points can be used to assess the quality of data from a buyer in any individual transaction, such as the buyer reviews of sellers, etc.); buyer code; buyer description; buyer qualitative data points A-X (multiple data points can be used to assess the quality of data from a buyer in any individual transaction, such as how frequently the buyer has purchased items); transaction data; item code; transaction description; source of transaction data; date of transaction; number of bids on transaction (if from an auction); auction time (if from an auction); source of transaction data; data source description; transaction qualitative points A-X (multiple data points can be used to assess the quality of data from any data source for any individual transaction). The market data analysis engine can employ mathematical and statistical analysis to present results to the user. The data population can include auction transactions AT (any record of a sale or attempted sale of an item between a buyer and a seller) and/or fixed data FD (a fixed appraisal or estimate of value for an item as of a point in time which can include suggested retail price).
Data population=sum of T=sum of AT+sum of FD
where in each transaction, I=item data from a transaction; S=seller (no if FD); B=buyer (no if FD); T=transaction; and O=source.

Variables can be appropriately weighted by using mathematical means such as basic coefficients of correlation, to measure the relevance to the desired result. Transaction or static market data points, for example prices from certain collectible database files that price or assess value for an item based on an estimate at a point in time, versus a transaction between a buyer and a seller, for items where I equals the item data found in the search would have a coefficient of correlation equal to 1.0. If however, the item was not the exact same item as sought by the potential bidder, but a similar item (similar condition, similar value) then the item transaction would have a coefficient of correlation less than 1.0 but greater than 0. A basic linear equation can be used to formulate data from the population and return the results to the user. During the market data mining operation 22, the valuation data analysis system 10 can notify the user as to the estimated time required to perform the search and return the data to the user. As the process can require some time to complete (for example, searches that require data from several disparate data sources and that pull a significant time for data in granular time intervals), users can elect to be notified when the search is complete.

After the market data analysis engine has completed the calculation, the data is ready to be returned to the end user. The data can be returned to the user in several optional formats including, but not limited to: (1) through an active browser window controlled by the valuation data analysis system 10; (2) via email; (3) text messaging to mobile devices. The search results can present the price related findings by calculating a range of prices for the item, in a standard bell curve format, determining mean, median and mode based on a series of related data points. The valuation data analysis system 10 according to the present invention can also present certain known prices related to the item: (1) current bid on the active auction site; (2) user's last bid on the auction site; and (3) user's maximum bid on the auction site. The valuation data analysis system 10 can present other information to assist the user with auction bid decisions, including but not limited to, price trend analysis—if an adequate time frame reference of data is available the tool can extrapolate a price trend for an item in an individual bid based on historical transactions and current open transactions, or across a broader time frame referencing a series of transactions where a transaction can be an item auctioned by a seller whether the item is ultimately sold or not. Seasonal trend analysis can be provided if an adequate time frame of reference data and data population is found. The valuation data analysis system 10 can present certain seasonal information about value that can indicate better times to shop, purchase, or bid for an item than others. Seller trend analysis can be provided if the population contains multiple market data for multiple sellers, then the system can plot market trends related to the item by seller. The valuation data analysis system 10 can also be configured to actively plot data points, presenting the data in a graphical format so a bidder can actively watch the trends as the trends emerge. In this mode of operation, the market data analysis engine and search agents can continue to collect data on a fixed interval supplying “real-time” updates to the user. This type of system operation is similar to real-time tools used to measure market momentum in stock and commodity markets.

The user can interact with the returned data, for example by modifying the data used to model value, such as adjusting the priorities of certain variables. For example, the user can change the calculation to place a higher priority on items sold in the last 30 days, or only data from a subset of source data sets. The user can also change the composition of the transaction data population by removing or adding transaction data. If these changes request the system to recalculate results from existing data, but with different parameters, then the existing population stored in a search table on the item market database 20 or data processing system 18 can be reexamined on the requested basis and the modified results returned to the user. If the user asks to seek more data, the system 10 can search for additional data as outline adding the located data to the data sampling population. If the user asks the system to remove certain data, the data can be flagged appropriately and excluded from the population data analysis, prior to the system reexamining the data and returning the modified results to the user. This procedure removes certain data from the calculations, but leaves the item transaction data permanently in the item market database 20.

Ultimately, the user can conclude the search process for the selected item and close the active session. Multiple active sessions can be maintained by the valuation data analysis system 10 for a user. The number of concurrent active sessions can be a term of the licensing agreement for the user of the valuation data analysis system 10 according to the present invention. Active sessions not closed by the user can be closed by the system 10 after a certain period of inactivity and/or efforts by the system 10 to notify the user to close the session. By way of example and not limitation, an email or browser-based message can be sent to notify the user of active sessions yet to be closed by a user.

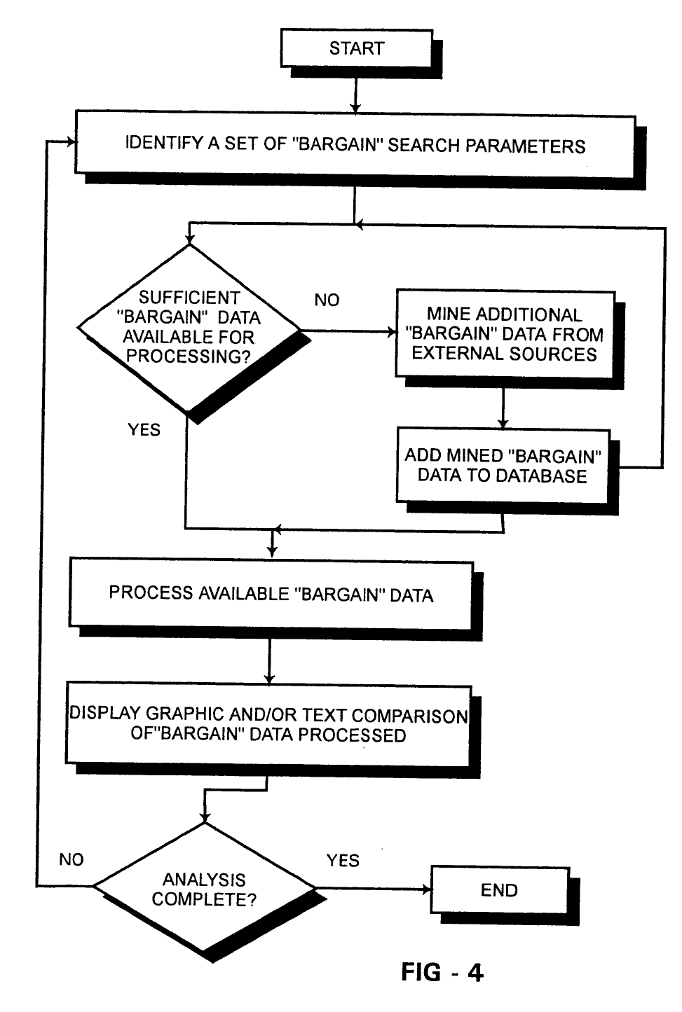

Referring now to FIG. 4, the second primary function of the valuation data analysis system 10 according to the present invention can provide the option for a purchaser or bidder to seek “bargains” from an online market place and/or auction site, by having the system 10 locate items available for purchase or bid that fall within certain value parameters established by the potential purchaser/bidder. By way of example and not limitation, an auction bidder in this case can be seeking items for auction where auction price based on current bids are a certain percentage below the value determined by the valuation data analysis system 10 including the tools search engine, database, and analysis engine, and where the auction is nearing completion and/or where there has been a minimal level of bidders and price movement. In this case, the user can invoke the valuation data analysis system 10 as described in greater detail above, selecting an option on the form to perform this second service or alternative process. The user can be presented with the next form which can allow the user to modify predefined parameters for this type of search based on predefined preferences and options, or enter necessary search parameters. Once parameters have been confirmed or entered, the user can initiate the system to perform either a one time search, or a persistent interval search. The objective of the search is to provide the user with a list of potential “bargains” available on an auction site. The process of determining a bargain requires determining the current bid price and market value for the item. Market value can be derived from the search capabilities and analysis engine of the valuation data analysis system 10 according to the present invention. Bid prices and items can be derived from the auction site. Given the potential challenge of searching for “bargains” across the entire auction site, users can be asked to narrow the search to those items and select a category or associate it with certain keywords. Further, market value can be determined only by data in the item market database 20. Searches for a wide scope of items, i.e. many items in a category, to the internet would be difficult with existing hardware and communication protocols and bandwidth.

A one time search can first establish a value or range for the item by following the same steps as described in greater detail above to derive value for an item, except the system will not perform an internet search unless only a single item is selected for bargain hunting. If the search has found adequate data to derive the value or range, the value range can be returned to the end user for review and confirmation before initiating the second search, looking for item prices in current auctions with certain price parameters. Once the user confirms acceptance of the results, the second search can commence and the search engine can scrape the selected auction web site for auction data related items being sought by the potential bidder. The analysis engine can then compare results from the auction web site for the value points identified in the parameters selected by the user and attempt to produce a list of items that fit the user's search criteria. The user's search criteria could include, by way of example and not limitation, all items in a particular category, and particular subcategory, where the current bid is less than or equal to 25 percent of the market value, and/or where there are less than 5 bidders, and/or where the remaining auction time is greater than or equal to 15 minutes. A persistent search interval can perform the same process as outlined above, except the valuation data analysis system 10 according to the present invention can repeat the search process on predefined intervals. The intervals can be selected within a predetermined range by the user. By way of example and not limitation, the valuation data analysis system 10 according to the present invention can persistently search data for “bargains” every X number of minutes as selected by the user.

The item market data according to the present invention can include information identifying the seller, purchaser, and/or bidders on a particular item. This information can be used in various combinations with other search criteria in order to identify sellers who may still be willing to sell unsold items where the original sale or auction was unsuccessful. In addition, the information can be used in combination with other search criteria to identify buyers who may have purchased items in the market place at below market values, since such buyers may be willing to resell items at an appropriate profit. The present invention also permits the seller/purchaser/bidder information to be used in combination with other search criteria in order to identify purchasers who in the past have been willing to pay more than market value in order to obtain a particular item, such as a rare collector's item, since such buyers may be interested in being informed when other rare items from similar collections become available.

The valuation data analysis system 10 according to the present invention can include a valuation data mining system 22 configured to extract valuation data from at least one of a plurality of publicly available listings 28 of items for sale, a non-public or privately available database 34 of previously sold items, and a valuation data processing system 18 configured to receive the valuation data. The data processing system 18 can be configured to process the valuation data to identify relationships between similar items currently listed for sale and previously sold items. The system 10 can also include a currently listed item for sale of interest to a potential buyer comparatively displayed with respect to valuation data based at least in part on the relationships identified by the valuation data processing system. The system 10 according to the present invention can include an auction web site hosting auctions of interest to a potential bidder. The valuation data can represent choices made by a potential buyer or bidder searching listings of items for sale. The valuation data can include at least one of an opening bid, a closing bid, and a completed sale price. The valuation data can also include an identification of currently listed items for sale or an identification of a previously sold item.

A method or process for the valuation data analysis system 10 according to the present invention can include the steps of identifying a set of item search parameters, identifying a plurality of auction listings based on the item search parameters, identifying valuation data for each of the identified plurality of auction listings, and displaying a comparison of auction listings as a function of the set of item search parameters based on at least one of the identified valuation data for the identified plurality of auction listings. The comparison can be displayed as related to at least one of a minimum closing price, a maximum closing price, and an average closing price from similar auction listings. The comparison can be displayed as a graphic and/or text data format. By way of example and not limitation, the comparison can be displayed as a graphic bell curve of closing prices for similar auction listings. The system 10 according to the present invention can include the step of permitting a potential buyer to place a bid on an item offered at auction based on at least one of the identified valuation data. The system 10 can also include the step of displaying the identified plurality of auction listings, where the valuation data for each of the plurality of auction listings has a different set of values than any of the other auction listings. The plurality of auction listings can be accumulated from a plurality of different on-line auction sites or from a single auction site.

The valuation data analysis system 10 according to the present invention can also identify a listed item open for bidding at auction, identify a plurality of auction listings for items similar to the item open for bidding, mining valuation data from the identified auction listings, and identifying relationships between the listed item open for bidding, closing prices for similar items, and the mining valuation data for the identified auction listings.

A method or process for the valuation data analysis system 10 according to the present invention can include the steps of identifying an item to be purchased, identifying a plurality of market places selling items similar to the identified item, selecting a market place based on at least one of the current sales of items similar to the identified item in the market place, bidding activity related to items similar to the identified item, comparison of quality characteristics related to items similar to the identified item, and comparison of sale completion data related to purchasers of items similar to the identified item, collecting data for items similar to the identified item offered in the identified market places, analyzing the data to determine supply and demand, and based on at least the determined supply and demand, determining a relative purchase price for the identified item in the market place. By way of example and not limitation, the market place can include on line auction web sites. The collected data can be analyzed to identify if sufficient data is available for a statistically meaningful comparison with the identified item. In addition, the collected data can be analyzed related items similar to identified item where the related items have quality characteristics different than quality characteristics associated with the identified item.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A valuation data analysis system comprising:
a valuation data mining system configured to extract valuation data from at least one of a plurality of publicly available listings of items for sale and a non-public database of previously sold items; and
a valuation data processing system configured to receive the valuation data, the data processing system configured to process the valuation data to identify relationships between similar items currently listed for sale and previously sold items.

2. The system of claim 1 further comprising a currently listed item for sale of interest to a potential buyer comparatively displayed with respect to valuation data based at least in part on the relationships identified by the valuation data processing system.

3. The system of claim 2 further comprising an auction web site, wherein the auction web site hosts auctions of interest to a potential bidder.

4. The system of claim 1, wherein the valuation data represent choices made by a potential buyer searching listed items for sale.

5. The system of claim 1, wherein the valuation data includes at least one of an opening bid, a closing bid, and a completed sale price.

6. The system of claim 1, wherein the valuation data includes an identification of a currently listed item for sale.

7. The system of claim 1, wherein the valuation data includes an identification of a previously sold item.

8. A method for a valuation data analysis system comprising the steps of:
identifying a set of item search parameters;
identifying a plurality of auction listings based on the item search parameters;
identifying valuation data for each of the identified plurality of auction listings; and
displaying a comparison of auction listings as a function of the set of item search parameters based on at least one of the identified valuation data for the identified plurality of auction listings.

9. The method of claim 8, wherein the comparison displayed is related to at least one of a minimum closing price, a maximum closing price, and an average closing price from similar auction listings.

10. The method of claim 8, wherein the comparison displayed is a graphic bell curve of closing prices from similar auction listings.

11. The method of claim 8 further comprising the step of permitting a potential buyer to place a bid on an item offered at auction based on at least one of the identified valuation data.

12. The method of claim 8 further comprising the step of displaying the identified plurality of auction listings, wherein the valuation data for each of the plurality of auction listings has a different set of values than any other of the auction listings.

13. The method of claim 8, wherein the plurality of auction listings are listed on a plurality of different on-line auction sites.

14. The method of claim 8, wherein the item search parameters result in displayed valuation data including identification data of at least one of a prior seller, a current seller, a prior purchaser, a prior bidder, and a current bidder.

15. A method for a valuation data analysis system comprising the steps of:
identifying a listed item open for bidding at auction;
identifying a plurality of auction listings for items similar to the item open for bidding;
mining valuation data from the identified auction listings; and
identifying relationships between the listed item open for bidding and closing prices for similar items, and the mined valuation data from the identified auction listings.

16. The method of claim 15 further comprising the step of displaying valuation data in at least one of text and graphic format for comparison and evaluation by a potential bidder.

17. The method of claim 16 further comprising the step of automated mining of valuation data from new auction listings.

18. The method of claim 17 further comprising the step of refining the identified relationships based at least on the mined valuation data from new auction listings.

19. The method of claim 15, wherein the mined valuation data includes identification data of at least one of a prior seller, a current seller, a prior purchaser, a prior bidder, and a current bidder.

20. A method for a valuation data analysis system comprising the steps of:
identifying an item to be purchased;
identifying a plurality of marketplaces selling items similar to the identified item;
selecting a marketplace based on at least one of current sales of items similar to the identified item in the marketplace, bidding activity related to items similar to the identified item, comparison of quality characteristics related to items similar to the identified item, and comparison of sale completion data related to purchasers of items similar to the identified item;
collecting data for items similar to the identified item offered in the identified marketplaces;
analyzing the data to determine supply and demand; and
based on at least the determined supply and demand, determining a relative purchase price for the identified item in the marketplace.

21. The method of claim 20, wherein the marketplace is an on-line auction marketplace.

22. The method of claim 21, wherein the on-line auction marketplace is selected based on the number of listings for items similar to the identified item.

23. The method of claim 20 further comprising the step of analyzing the collected data to identify if sufficient data is available for a statistically meaningful comparison with the identified item.

24. The method of claim 20 further comprising the step of analyzing the collected data to identify related items similar to the identified item, where the related items have quality characteristics different than quality characteristics associated with the identified item.

25. The method of claim 20, wherein the collected item data includes identification data of at least one of a prior seller, a current seller, a prior purchaser, a prior bidder, and a current bidder.
